(19) United States
(12) Patent Application Publication
(10) Pub. No.: US 2017/0304755 A1
(43) Pub. Date: Oct. 26, 2017

(54) MULTI-LAYERED OR MULTIPLE POLYMER FINE FIBER WEBS

(71) Applicants: Vishal Bansal, Lee's Summit, MO (US); Thomas D. Carr, Franklin, TN (US); Yogesh Ner, Spring Hill, TN (US); Kaiyi Liu, Spring Hill, TN (US); Stephen R. Kay, Austin, TX (US)

(72) Inventors: Vishal Bansal, Lee's Summit, MO (US); Thomas D. Carr, Franklin, TN (US); Yogesh Ner, Spring Hill, TN (US); Kaiyi Liu, Spring Hill, TN (US); Stephen R. Kay, Austin, TX (US)

(73) Assignee: CLARCOR Inc., Franklin, TN (US)

(21) Appl. No.: 15/493,266

(22) Filed: Apr. 21, 2017

Related U.S. Application Data
(60) Provisional application No. 62/326,554, filed on Apr. 22, 2016.

(51) Int. Cl. B01D 39/16; D01D 4/02; D04H 1/724

(52) U.S. Cl. CPC B01D 39/163; D04H 1/724; D01D 4/025; B01D 2239/0457; B01D 2239/0442; B01D 2239/0407; B01D 2239/025; B01D 2239/1233; B01D 2239/10

(57) ABSTRACT

A material comprising unique nanofiber layers, and more particularly, this invention relates to a method for creating a material that is made from multiple unique nanofiber layers that can be utilized as filter media among other applications. The nanofiber layers have a plurality of fine fibers with an average diameter of less than 1 micron. In embodiments, the fine fibers are formed from a polymer. The material can be created according to a method in which the fine fiber strands are formed from a polymer melt or a polymer solution. The fine fibers can then be layered on top of one another to form materials such as filter media.

### CROSS-REFERENCE TO RELATED PATENT APPLICATIONS

This patent application claims the benefit of U.S. Provisional Patent Application No. 62/326,554, filed Apr. 22, 2016, the entire teachings and disclosure of which are incorporated herein by reference thereto.

### FIELD OF THE INVENTION

This invention generally relates a material made from multiple unique nanofiber layers, and more particularly, this invention relates to a method for creating a material that is made from multiple unique nanofiber layers that can be utilized as filter media among other applications.

### BACKGROUND OF THE INVENTION

Methods of and apparatuses for producing nanofibers are known by way of centrifugal spinning. Exemplary disclosures include U.S. Publication Nos. 2016/0083867, 2016/0069000, 2015/0013141, 2014/0339717, 2014/0217629, 2014/0217628, 2014/0159262, 2014/0042651, 2014/035179, 2014/0035178, 2014/0035177, 2012/0295021, and 2012/0294966 and U.S. Pat. Nos. 9,181,635; 8,778,240; 8,709,309; 8,647,541; and 8,647,540. These entire disclosures are incorporated in their entireties herein by reference. As such, centrifugal spinning, spinnerets, materials, and methods disclosed in these references are preferred for use in an embodiment of the present invention that provides for improvements and new uses for such centrifugal spinning systems.

### BRIEF SUMMARY OF THE INVENTION

The inventive aspects and embodiments discussed below in the following separate paragraphs of the summary may be used independently or in combination with each other.

In one aspect, a filter media is provided comprising polymeric fine fibers, including a first layer of fine fibers and a second layer of fine fibers. The first layer of fine fibers and the second layer of fine fibers have an average diameter of less than 1 micron and the first layer of fine fibers are unique relative to the second layer of fine fibers

In certain embodiments, the first layer of fine fibers will be composed of a first polymer and the second layer will be composed of a second polymer that is different than the first polymer.

In another aspect, the filter media has a substrate layer and an outermost layer comprising the second layer of fine fibers, with the first layer therebetween. The outermost layer comprises a flame retardant polymer while the first layer does not comprise a flame retardant polymer.

In another aspect, the flame retardant polymer will comprise at least one of Aramids, Polyimide, Polyetherimide, or liquid crystal polymers.

In a particular embodiment, a filter media where the fine fibers of one of the first and second layers includes an additive integral with the fine fibers, and the fine fibers of the other layer is free of the additive.

In a certain embodiment, the additive comprises at least one of colorant, antioxidant, antimicrobial, catalytic materials, absorbents, TiO2, or enzymes.

In a preferred embodiment, the fine fibers of the first and second layers are of different size diameters, including second fine fibers of the second layer that are at least 10% larger than the first fine fibers of the first layer.

In some applications, the filter media has a substrate layer and an outermost upstream layer that is optionally the second layer, with the first layer between the second layer and the substrate and downstream of the outermost upstream layer, to position larger size fine fibers upstream to form a prefilter layer.

In a further aspect, the fine fibers of the first and second layers are of different cross-sectional shapes.

In still another aspect, the polymeric fine fibers include a polymer that is at least one selected from a group consisting of: polyester, polypropylene, cellulose acetate, polyphenylene sulfide, polyamide, polytetrafluoroethylene, polyvinylidene fluoride, and other fluoropolymer.

According to another aspect, the step of making a filter media comprising forming the first layer of fine fiber strands from a polymer melt or a polymer solution and then forming the second layer of fine fiber strands from a polymer melt or a polymer solution, where the second layer of fine fibers is laid down on top of said first layer of fine fibers.

In another step, the forming of the first layer of fine fiber strands further comprises centrifugal spinning the first layer of fine fibers by centrifugally expelling a liquid polymer that comprises at least one of polymer melt or polymer solution, through orifices in a first spinneret while rotating the spinneret at a speed of at least 2500 rpms and drawing down a fiber diameter of the first layer of fine fibers through centrifugal force to draw down the fiber diameter.

In still another step, forming the second layer of fine fiber strand by centrifugal spinning the second layer of fine fibers by centrifugally expelling a liquid polymer that comprises at least one of polymer melt or polymer solution, through orifices in a second spinneret while rotating the spinneret at a speed of at least 2500 rpms and drawing down a fiber diameter of the second layer of fine fibers through centrifugal force without using electrospinning forces to draw down the fiber diameter.

In yet another step, the forming forms the first and second layer of fine fiber strands that have a length greater than 1 millimeter and an average diameter of less than 1 micron.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic depiction of a piece of filter media made from multiple unique nanofiber layers according to an exemplary embodiment of the present invention;

FIG. 2 is a schematic depiction of a piece of filter media made from multiple unique nanofiber layers according to an exemplary embodiment of the present invention;

FIG. 3 is a schematic depiction of a piece of filter media made from multiple unique nanofiber layers according to an exemplary embodiment of the present invention;

FIG. 4 is a schematic depiction of a piece of filter media made from multiple unique nanofiber layers according to an exemplary embodiment of the present invention;

FIG. 5 is a schematic depiction of a piece of filter media made from multiple unique nanofiber layers according to an exemplary embodiment of the present invention;

FIG. 6 is a schematic depiction of a piece of filter media made from multiple unique nanofiber layers according to an exemplary embodiment of the present invention;

FIG. 7 is a schematic depiction of a piece of filter media made from multiple unique nanofiber layers according to an exemplary embodiment of the present invention;

FIG. 8 is a schematic depiction of a manufacturing line (not to scale) for creating a material made from multiple unique nanofiber layers according to an exemplary embodiment of the present invention;

FIG. 9 depicts a multitude of spinnerets for centrifugal spinning of the nanofibers in the deposition chamber of the manufacturing line in FIG. 8;

FIG. 10 depicts a multitude of spinnerets for centrifugal spinning of a material made from multiple unique nanofiber layers in the deposition chamber of the manufacturing line of FIG. 8; and

FIG. 11 depicts another embodiment of a multitude of spinnerets for centrifugal spinning of a material made from multiple unique nanofiber layers in the deposition chamber of the manufacturing line of FIG. 8.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

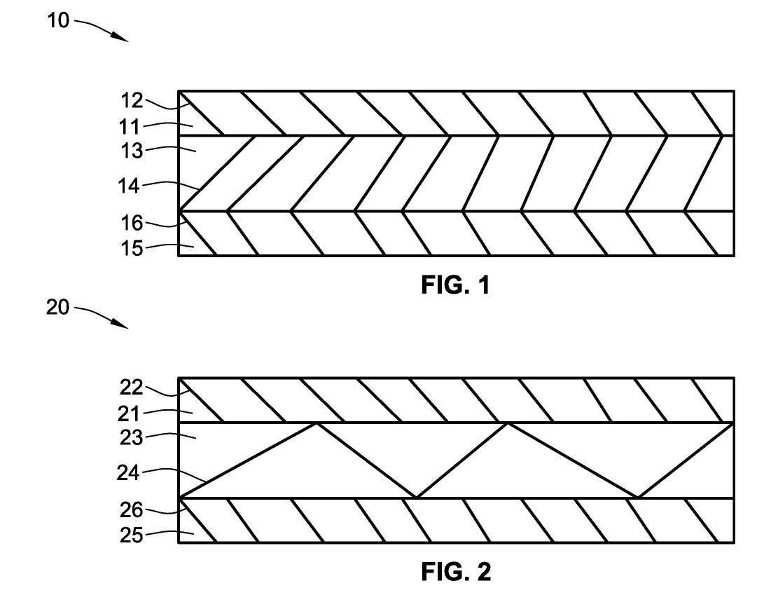

FIG. 1 depicts an exemplary, schematic embodiment of a cross-section of filter media 10 according to one aspect of the present application. The filter media 10 has a substrate layer 15 and a first layer 13 of fine fibers 14, and a second layer 11 of fine fibers 12. In the embodiment, the first fine fiber 14 and the second fine fiber 12 are of comparable diameter, but the first fine fibers 14 are made from one polymer and the second fine fibers 12 are made from a polymer that is different from the first fine fibers 14.

As will be appreciated by one of ordinary skill in the art, filter media 10 having a first layer 13 that is composed of finer fibers 14 of one polymer and a second layer 11 that is composed from a fine fiber 12 of a different polymer than the fine fibers 14 of the first layer 13 provides many advantages.

In one exemplary embodiment the second layer 11 could be composed of fine fibers 12 that are made with a flame retardant polymer, such as but not limited to, a polymer that comprises at least one of Aramids, Polyimide, Polyetherimide, or liquid crystal polymers. Such a filter media 10 could be used in air filtration applications where sparks or other forms of flames are going to be present such as going into metal casting operations where sparks may carry over to the filter media 10, which requires that the second or outer layer 11 that could be exposed to the sparks be flame retardant.

However, as will also be appreciated by one of skill in the art, the polymers needed to make fine fibers 12 flame retardant are relatively expensive compared to other polymers that are not flame retardant. Therefore, instead of having to manufacture a filter media that is composed of entirely flame retardant fine fibers a user could manufacture a piece of filter media 10 where the second or outer layer 11 is composed of fine fibers 12 that are flame retardant, while the inner layer 13, which is protected from being exposed from sparks by the outer layer 11, can be composed fine fibers 14 that are made from a less expensive non-flame retardant polymer.

Turning to FIG. 2 depicting an exemplary schematic embodiment of a cross-section of filter media 20 according to one aspect of the present application. The filter media 20 has a first layer 21 made of a first fine fiber 22, a second layer 23 made of a second fine fiber 24, and a third layer 25 made of a third fine fiber 26. The fine fiber 22 of the first layer 21 and the fine fiber 26 of the third layer 25 have a diameter that is less than the fine fiber 24 of the second layer 23. All three layers 21, 23, and 25 could be made from different fine fibers or layers 21 and 25 could be similar or the same size fine fibers (i.e. such as in diameter.

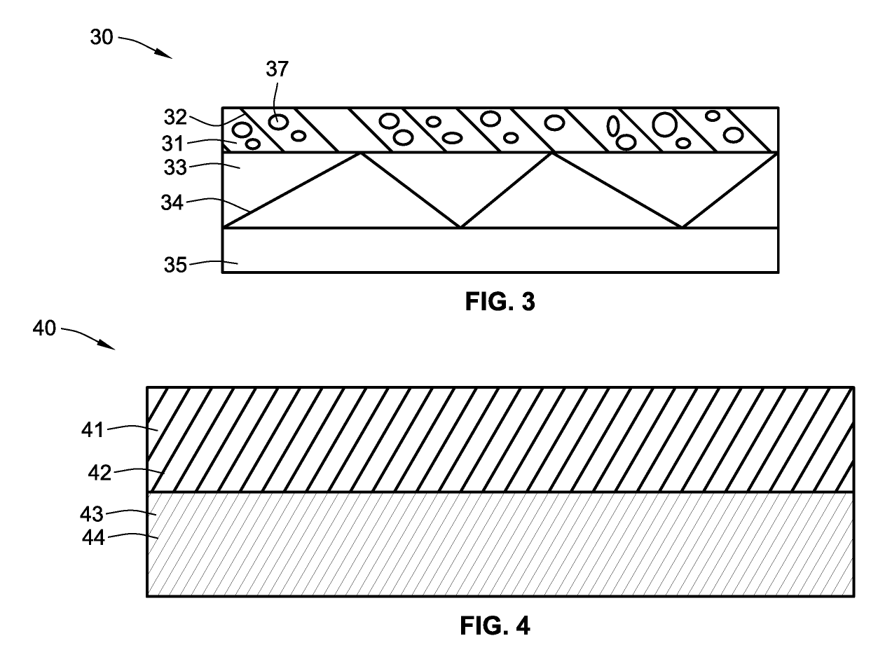

Turning to FIG. 3 depicting an exemplary schematic embodiment of a cross-section of filter media 30 according to one aspect of the present application. The filter media 30 has a substrate layer 35, a first layer 33, and a second layer 31. The second layer 31 is made from fine fibers 32 comprising a polymer that is integrally mixed with an additive 37. While the first layer 33 is made from fine fibers 34 comprising a polymer that does not contain any additives 37. While this embodiment utilizes substrate layer 35 other embodiments may eliminate substrate layer 35. The substrate layer may be formed from PTFE and other fluoropolymer, polyamide, polyester, cellulose, polypropylene, etc.

As will be appreciated by one having ordinary skill in art, integrally mixing additives 37 with a polymer to make fine fibers 32 having additives integral with the fine fibers 32 is more expensive and time consuming than manufacturing fine fibers 34 that does not contain additives 37. Additives 37 can only be effective when they are located on the outer layer 31 of the filter media 30. Thus, in order to reduce the expense and time of manufacturing fine fibers 32 having additives 37 integral to the fine fibers 32 a user can manufacture a filter media 30 where only the fine fibers 32 making up the second or outer layer 31 are have additives 37 integral to the fine fibers 32 and the fine fibers 34 of the first or inner layer 33 do not need to be made from a polymer including additives 37.

Alternatively, the layers could be reversed if it may be beneficial to have an inner layer include the additives 37 as opposed to the outer layer. Such an example may be where the additive 37 is focused at small particulate, and the outer layer is designed for removing large particulate and the inner layer is designed to remove the smaller particulates affected by the additives, such as in the embodiment of FIG. 4 described below.

Further, yet while FIG. 3 depicts only one layer being mixed with an additive 37 multiple layers could be mixed with different additives.

Turning to FIG. 4 depicting an exemplary schematic embodiment of a cross-section of filter media 40 according to one aspect of the present application. The filter media 40 has a first layer 43 and a second layer 41. The second layer 41 is composed of fine fibers 42 having a diameter greater than the diameter of the fine fiber 44 of the first layer 43. In one exemplary embodiment the fine fibers 42 of the second layer 41 have a diameter that is at least 10% greater than the fine fibers 44 of the first layer 43.

During use, the filter media 40 can be implemented in high capacity filters where the larger diameter fine fibers 42 of the second layer 41 can act as a pre-filter where the smaller diameter fine fibers 44 of the first layer 43 can act to perform fine particle filtration. Further, more than two layers can be provided with decreasing diameter when moving from one layer to the next.

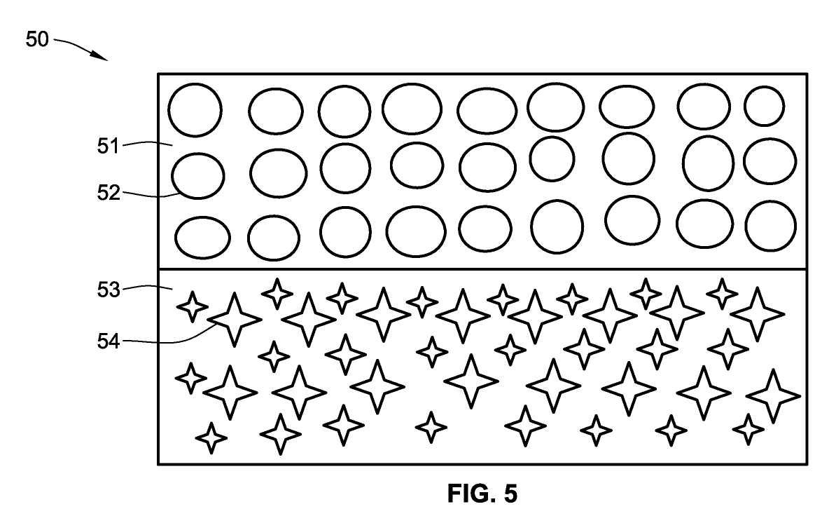

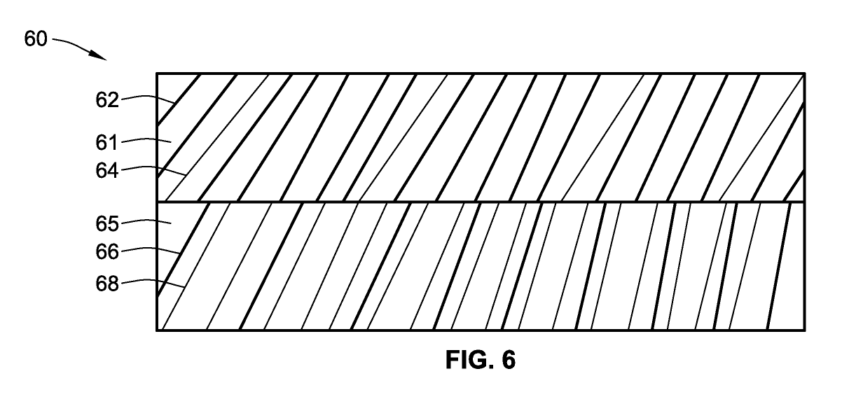

FIG. 5 depicts an exemplary schematic embodiment of a cross-section of filter media 50 according to one aspect of the present application. The filter media 50 has a first layer 51 and a second layer 53. The first layer 51 is composed of fine fibers 52 having a first cross-sectional shape and the second layer 52 is composed of fine fibers 54 having a second cross-sectional shape that is different than the cross-sectional shape of the fine fibers 52 of the first layer 51.

In the illustrated embodiment the cross-sectional shape of the fine fibers 52 in the first layer 51 is circular and the cross-sectional shape of the fine fibers 54 in the second layer 53 is that of a four pointed star. The fine fibers 54 having a cross-sectional shape of a four pointed star may have a larger surface area than the fine fibers 52 having a circular cross-sectional shape in the first layer 51.

As the cross-sectional area of a fine fiber increases in a filter media, the finer particles the fine fibers will be capable of filtering. Thus, in the illustrated embodiment, the first layer 51 of the filter media 50 can act as a pre-filter to filter out larger sized particles and the second layer 53 can act to perform fine particle filtration because of smaller surface area of the fine fibers 52 of the first layer 51 of the filter media 50 relative to the larger surface area of the fine fibers 54 of the second layer 53 of the filter media 50.

Further, fine fibers having different cross-sectional shapes could also have additives added to them.

FIG. 6 depicts an exemplary schematic embodiment of a cross-section of filter media 60 according to one aspect of the present application. The filter media 60 has a first layer 61 and a second layer 65. The first layer 61 is composed of a first fine fiber 62 and a second fine fiber 64 and the second layer 65 is composed of a first fine fiber 66 and a second fine fiber 68. In the illustrated embodiment, the first fine fiber 62 of the first layer 61 has an average diameter that is equal to the average diameter of the first fine fiber 66 of the second layer 65. Likewise, the second fine fiber 64 of the first layer 61 has an average diameter that is equal to the average diameter of the second fine fiber 68 of the second layer 65.

However, as illustrated in FIG. 6 the number of the first fine fibers 62 in the first layer 61 is greater than the number of the second fine fibers 64 in the first layer 61. On the other hand, the number of the first fine fibers 66 in the second layer 65 is less than the number of the second fine fibers 68 in the second layer 65. Because the first layer 61 has a greater number of the larger diameter first fine fibers 62 relative to the number of the smaller diameter second fine fibers 64, the first layer 61 can act as the pre-filter layer in a high capacity filter media. Furthermore, as the second layer 65 has a greater number of the smaller diameter second fine fibers 68 relative to the larger diameter first fine fibers 66 the second layer 65 the second layer 65 can act as the fine particle filter in a high capacity filter media.

In an alternative embodiment, all layers need not have a mixture of both the first and second fibers.

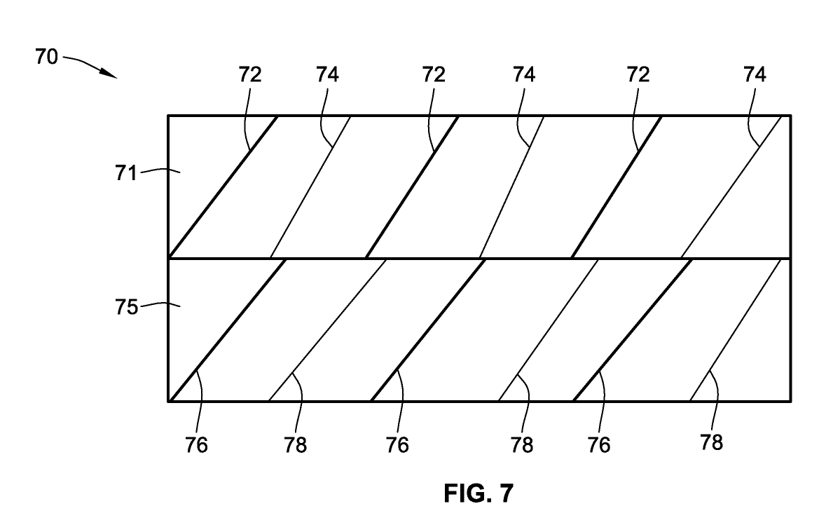

FIG. 7 depicts an exemplary schematic embodiment of a cross-section of filter media 70 according to one aspect of the present application. The filter media 70 has a first layer 71 and a second layer 75. The first layer 71 is composed of a first fine fiber 72 and a second fine fiber 74. The second layer 75 is also composed of a first fine fiber 76 and a second fine fiber 78. The first fine fiber 72 of the first layer 71 has an average diameter that is larger than the average diameter of the first fine fiber 76 of the second layer 75 and the first fine fiber 76 of the second layer 75 has an average fiber diameter that is larger than the average diameter of the second fine fiber 78 of the second layer 75 while the second fine fiber 78 of the second layer 75 has an average fiber diameter that is greater than the average diameter of the second fine fiber 74 of the first layer 71 such that the mean fiber size of the first fine fiber 72 and the second fine fiber 74 of the first layer 71 is comparable to the mean fiber size of the first fine fiber 76 and the second fine fiber 78 of the second layer 75.

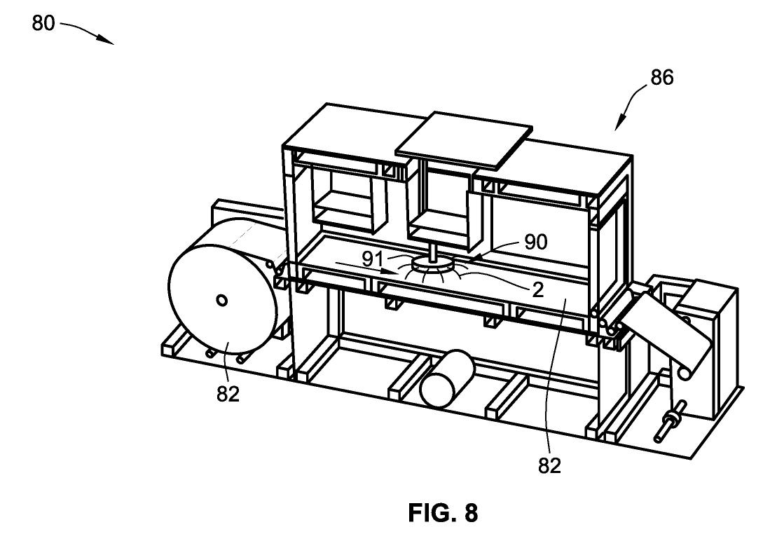

FIG. 8 depicts an exemplary, schematic embodiment of a manufacturing line 80 for creating multilayered filter media described herein and otherwise contemplated.

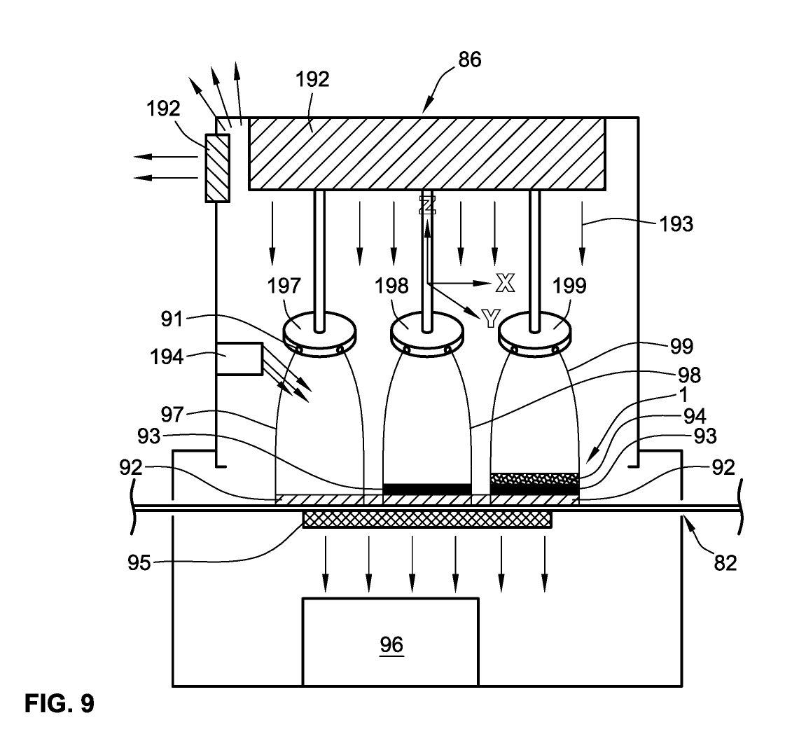

As shown in FIG. 8 and with additional reference to FIG. 9, initially, fine fibers 2 are formed into a sheet 3 in a fiber deposition chamber 86. The fine fibers 2 are preferably produced via centrifugal spinning (also referred to herein as “Forcespinning®”) and deposited on a moving substrate 82. The moving substrate 82 can be incorporated into the sheet 3, such as a scrim material, or the moving substrate 82 can be separate from the sheet 3, such as a conveyor system (not shown).

FIG. 9 depicts a more detailed schematic view of a section of the fiber deposition chamber 86. As depicted in FIGS. 8 and 9, the deposition chamber 86 is a FORCESPINNING® chamber. FORCESPINNING® involves centrifugally expelling a liquid polymer (i.e., at least one of a polymer melt or polymer solution) through orifices 91 in at least one spinneret 90, 197, 198, 199 while rotating the spinneret 90, 197, 198, 199 at a speed of at least 2500 rpms. This centrifugal action results in the drawing down of the fiber diameter of the fine fibers. It should be noted that the FORCESPINNING® action draws down the diameter of the fine fibers 2 without the use of electrospinning forces.

The deposition chamber 86 of FIG. 8 depicts a single spinneret 90, but the deposition chamber 86 may include a multitude of spinnerets, such as shown in FIGS. 9-11, depending on how many layers or characteristics are needed for an individual piece of filter media.

FIG. 9 illustrates a deposition chamber 86 having a first spinneret 197, a second spinneret 198 and a third spinneret 199. Typically the spinnerets 197, 198, and 199 are capable of moving along the X, Y, and Z axes to provide a range of coverage options for producing their respective layers of filter media 92, 93, and 94. Each spinneret 197, 198, and 199 features a plurality of orifices 91 through which their respective fine fibers 97, 98, and 99 are expelled.

For each individual spinneret 197, 198, and 199, each of their individual orifices 91 can each be connected to the same reservoir of polymer melt, polymer solution, or liquid adhesive, or each orifice 91 can be connected to a different reservoir of polymer melt, polymer solution, or liquid adhesive or combination thereof. Furthermore, each spinneret 197, 198, 199 can expel a different polymer melt, polymer solution, or liquid adhesive independent of one another. During fine fiber deposition, the spinnerets 197, 198, and 199 will rotate at least at 2500 rpms. More typically, the spinnerets 197, 198, and 199 will rotate at least at 5000 rpms.

Each spinneret 197, 198, and 199 can be used to create fine fibers 97, 98, and 99 using, for example, a solution spinning method or a melt spinning method. A polymer melt can be formed, for example, by melting a polymer or a polymer solution may be formed by dissolving a polymer in a solvent. Polymer melts and/or polymer solutions as used herein also refers to the material formed from heating the polymer to a temperature below the melting point and then dissolving the polymer in a solvent, i.e., creating a “polymer melt solution.” The polymer solution may further be designed to achieve a desired viscosity, or a surfactant may be added to improve flow, or a plasticizer may be added to soften a rigid fiber, or an ionic compound may be added to improve solution conductivity. The polymer melt can additionally contain polymer additives, such as antioxidant or colorants.

In FIG. 9, spinneret 197 is illustrated as forming a first fine fiber 97 that forms a first layer 92 of filter media. Further, spinneret 198 is illustrated forming a second fine fiber 98 that forms a second layer 93 that is layered atop the first layer 92 of filter media. Finally, spinneret 199 is illustrated forming a third fine fiber 99 that forms a third layer 94, which is illustrated as being layered atop the second layer 93 of the filter media. In the illustrated embodiment, the first fine fiber 97 is shown as having a smaller fiber diameter than the second fine fiber 98 and the second fine fiber 98 is shown as having a smaller fiber diameter than the third fine fiber 99, thereby, forming a filter media having a first layer 92, second layer 93, and third layer 94 that are each formed from fine fibers 97, 98, and 99 having different fiber diameters.

Several optional features of the deposition chamber 86 are depicted in FIG. 9. Generally, the fine fibers 97, 98, 99 are preferably continuous fibers. The fine fibers 97, 98, 99 can be encouraged downwardly to collect on the moving substrate 82 through a variety of mechanisms that can work independently or in conjunction with each other. For example, in some embodiments, a gas flow system 192 can be provided to induce a downward gas flow, depicted with arrows 193. The gas flow system 192 can also include lateral gas flow jets 194 that can be controlled to direct gas flow in different directions within the deposition chamber 86.

Additionally, in some embodiments, formation of the fine fibers 97, 98, and 99 will induce an electrostatic charge, either positive or negative, in the fiber. An electrostatic plate 95 can be used to attract the charged fibers 97, 98, and 99 downwardly to the moving substrate 82. Thus, as can be seen in FIG. 9, the electrostatic plate 95 is located below the moving substrate 82. Furthermore, in some embodiments, a vacuum system 96 is provided at the bottom of the deposition chamber 86 to further encourage the fine fibers 97, 98, and 99 to collect on the moving substrate 82. Still further, in some embodiments, an outlet fan 192 is provided to evacuate any gasses that may develop, such as might develop as the result of solvent evaporation or material gasification, during the FORCESPINNING® process.

As illustrated in FIG. 9, spinneret 197 makes a first fine fiber 97 and deposits on substrate 82 to make a first layer 92 of filter media 1. Then spinneret 198 makes a second fine fiber 98 having different characteristics than the first fine fiber 97 and deposits the second fine fiber 98 as a second layer 93 atop the first layer 92. Finally, spinneret 199 forms a third fine fiber 99 that has different characteristics than the first fine fibers 97 or the second fine fibers 98 and deposits them atop the second layer 93 to form a third layer 94 of the filter media 1.

The fine fibers 97, 98, and 99 can have, but are not limited to, characteristics, such as having different fiber diameters, different fiber cross-sectional shaped, different polymer compositions, such as but not limited to including, material is made is preferably selected from, but not limited to, the group consisting of polyester, polypropylene (PP), cellulose acetate (CA), polyurethanes (such thermoplastic polyurethanes TPU), polyphenylene sulfide (PPS), polyamides (such as Nylons), polytetrafluoroethylene (PTFE), polyvinylidene flouride (PVDF), and other fluoropolymers, and could also include additional chemicals added to the polymers such as an adhesive or additive.

In other embodiments, the fine fibers 197, 198, and 199 can be deposited using a different method than FORCESPINNING® or in conjunction with FORCESPINNING®. For example, in one embodiment, the fine fiber 2 can be produced via electrospinning.

The fine fiber 197, 198, and 199 that are incorporated into the filter media 1 will typically have an average diameter of less than 1 micron.

The FORCESPINNING® of the fine fibers 197, 198, and 199 especially the continuous strands, entangles the fine fibers 197, 198, and 199 with each other to form the filter media 1 having a first, second and third layer 92, 93, and 94 composed of unique fine fibers 197, 198, and 199.

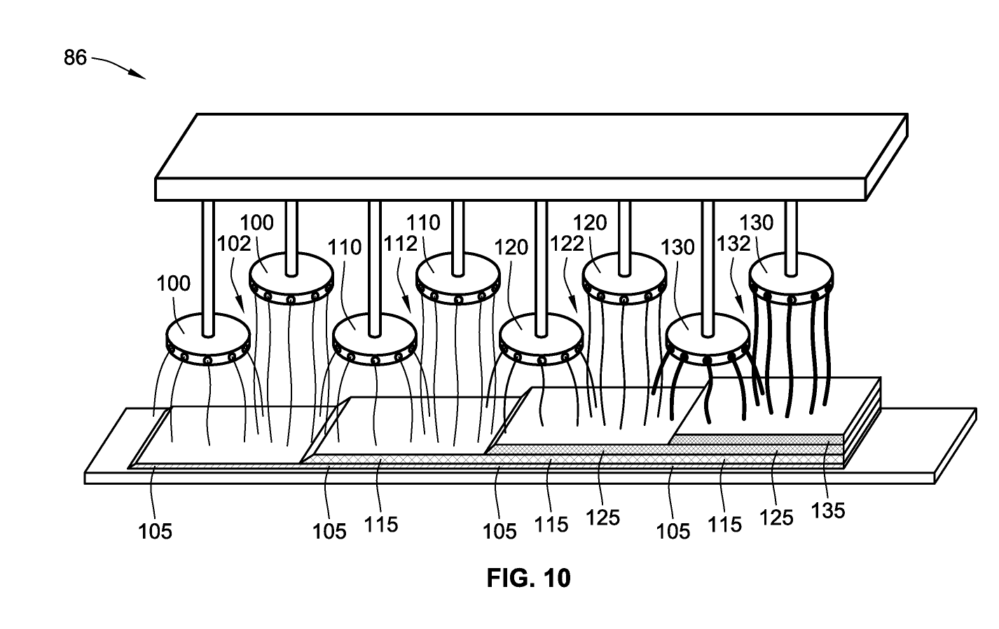

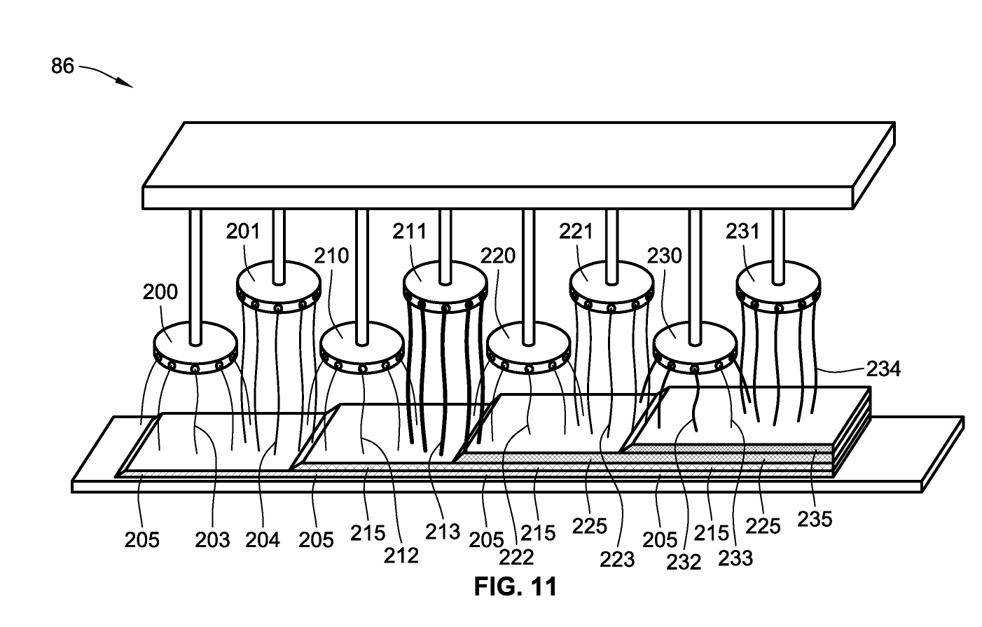

FIG. 10 illustrates another embodiment of a deposition chamber 86 having a first pair of spinnerets 100, a second pair of spinnerets 110, a third pair of spinnerets 120, and a fourth pair of spinnerets 130. The first pair of spinnerets 100 are each shown forming a first fine fiber 102. The second pair of spinnerets 110 are shown forming a second fine fiber 112. The third pair of spinnerets 120 are shown forming a second fine fiber 122 and the fourth pair of spinnerets 130 are shown forming a third fine fiber 132.

As illustrated the first pair of spinnerets lay down a first fine fiber layer 105. Then, the second pair of spinnerets lay down a second fiber layer 115 having different characteristics than the first fine fiber layer 105. Then the third pair of spinnerets 120 lay a third fine fiber layer 125 that has different characteristics than the first fine fiber layer 105 or the second fine fiber layer 115. Finally, the fourth pair of spinnerets 130 lays down a fourth fine fiber layer 135 having different characteristics than the first fine fiber layer 105, the second fine fiber layer 115, or the third fine fiber layer 125.

Turning to FIG. 11 illustrating another embodiment of a deposition chamber 86 illustrating a first spinneret 200 and second spinneret 201 forming a first spinneret pair, a third spinneret 210 and a fourth spinneret 211 forming a second spinneret pair, a third fifth spinneret 220 and sixth spinneret 221 forming a third spinneret pair and a seventh spinneret 230 and an eight spinneret 231 forming a fourth spinneret pair.

The first spinneret is illustrated producing a first fine fiber 203 having a fiber diameter that is less than the fiber diameter of the second fine fiber 204 being formed by the second spinneret 201. Thus, the first fine fiber layer 205 will be composed of different fine fibers 203 and 204 having different diameters. Next the third spinneret 210 is illustrated as laying down a first fine fiber 212 and the fourth spinneret is illustrated laying down a second fine fiber 213 having an additive 37 (see FIG. 3). Thus, the second layer 215 being laid down atop the first layer 205 is composed of fine fibers 212 and fine fibers 213 having an additive 37 integral to the fine fibers 213.

Next, the fifth spinneret 230 is producing a fine fiber 222 and the sixth spinneret is producing a fine fiber 223 that includes an adhesive. Thus, the third fine fiber layer 225 being laid down atop the second fine fiber layer 215 includes fine fibers 222 and fine fibers 223 that include an adhesive integral to the fine fibers 223. Next, seventh spinneret 230 is producing a first fine fiber 232 and a second fine fiber 233. The first fine fiber 232 having a larger diameter than the second fine fiber 233. Finally, the eight spinneret 231 is illustrated producing a fine fiber 234 that that is composed of a different polymer than the first fine fiber 232 and the second fine fiber 233 being produced by the seventh spinneret 230. Thus, the fourth fine fiber layer 235 being laid down atop the third fine fiber layer 225 includes fine fibers 232 and 233 having different diameters along with fine fiber 234 that is made from a different polymer than fine fibers 232 and 233.

While the different spinnerets in each spinneret pair are illustrated forming different diameter fibers, the difference between the spinnerets in a pair could be different characteristics such as, but not limited to, characteristics, such as having different fiber diameters, different fiber cross-sectional shaped, different polymer compositions, such as but not limited to including, material is made is preferably, but not limited to be selected from the group consisting of polyester, polypropylene (PP), cellulose acetate (CA), polyphenylene sulfide (PPS), polyamides (such as Nylons), polyurethanes (such thermoplastic polyurethanes TPU), polytetrafluoroethylene (PTFE), polyvinylidene flouride (PVDF), and other fluoropolymers, and could also include additional chemicals added to the polymers such as an adhesive or additive.

In embodiments, the fine fibers are preferably formed from a polymer. The polymer from which the material is made is preferably selected from the group consisting of polyester, polypropylene (PP), cellulose acetate (CA), polyphenylene sulfide (PPS), polyamides (such as Nylons), polyurethanes (such thermoplastic polyurethanes TPU), polytetrafluoroethylene (PTFE), polyvinylidene flouride (PVDF), and other fluoropolymer.

In addition, the spinneret of manufacturing process shown in FIGS. 9-11 can be adjusted to vary output of fibers thereby controlling the weight of individual layers in the exemplary multilayer media shown in FIGS. 1-7.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter media comprising:
polymeric fine fibers, including a first layer of fine fibers and a second layer of fine fibers;
wherein the first layer of fine fibers and the second layer of fine fibers have an average diameter of less than 1 micron; and
wherein the first layer of fine fibers are unique relative to the second layer of fine fibers.

2. The filter media of claim 1, wherein the first layer of fine fibers comprises a first polymer and the second layer comprises a second polymer different than the first polymer.

3. The filter media of claim 2, wherein the filter media has a substrate layer and an outermost layer comprising the second layer of fine fibers, with the first layer therebetween.

4. The filter media of claim 3, wherein the outermost layer comprises a flame retardant polymer, and wherein the first layer does not comprise a flame retardant polymer.

5. The filter media of claim 4, wherein the flame retardant polymer comprises at least one of Aramids, Polyimide, Polyetherimide, or liquid crystal polymers.

6. The filter media of claim 1, wherein the fine fibers of one of the first and second layers an additive integral with the fine fibers, and wherein the fine fibers of the other one of the first and second layers is free of the additive.

7. The filter media of claim 6, wherein the filter media has a substrate layer and an outermost layer comprising the second layer of fine fibers, with the first layer therebetween, and wherein the outermost layer has the additive integral with the fine fibers.

8. The filter media of claim 7, wherein the additive comprises at least one of colorant, antioxidant, antimicrobial, catalytic materials, absorbents, TiO₂, or enzymes.

9. The filter media of claim 1, wherein the fine fibers of the first and second layers are of different size diameters, including second fine fibers of the second layer that are at least 10% larger on average than the first fine fibers of the first layer.

10. The filter media of claim 9, wherein the filter media has a substrate layer and an outermost upstream layer that is optionally the second layer, with the first layer between the second layer and the substrate and downstream of the outermost upstream layer, to position larger size fine fibers upstream to form a prefilter layer.

11. The filter media of claim 1, wherein the fine fibers of the first and second layers are of different cross-sectional shapes.

12. The material of claim 1, wherein the polymeric fine fibers include a polymer that is at least one selected from a group consisting of: polyester, polypropylene, cellulose acetate, polyphenylene sulfide, polyamide, thermoplastic polyurethanes, polytetrafluoroethylene, polyvinylidene fluoride, and other fluoropolymer.

13. A method of forming the filter media of claim 1, comprising:
forming the first layer of fine fiber strands from a polymer melt or a polymer solution; and
forming the second layer of fine fiber strands from a polymer melt or a polymer solution;
wherein said second layer of fine fibers is laid down on top of said first layer of fine fibers.

14. The method of claim 13, wherein the forming of the first layer of fine fiber strands further comprises:
centrifugal spinning the first layer of fine fibers by centrifugally expelling a liquid polymer that comprises at least one of polymer melt or polymer solution, through orifices in a first spinneret while rotating the spinneret at a speed of at least 2500 rpms.

15. The method of claim 14, wherein the forming of the second layer of fine fiber strands further comprises:
centrifugal spinning the second layer of fine fibers by centrifugally expelling a liquid polymer that comprises at least one of polymer melt or polymer solution, through orifices in a second spinneret while rotating the spinneret at a speed of at least 2500 rpms.

16. The method of claim 13, wherein the forming forms the first and second layer of fine fiber strands that have a length greater than 1 millimeter and an average diameter of less than 1 micron.
